(19) United States
(12) Patent Application Publication
(10) Pub. No.: US 2015/0185127 A1
(43) Pub. Date: Jul. 2, 2015

(54) PRESERVATION METHOD AND PRESERVATION HOLDER

(71) Applicant: FUKAE KASEI CO., LTD., Hyogo (JP)

(72) Inventors: Tadashi HOSOKAWA, Hyogo (JP); Yukari AKIYOSHI, Hyogo (JP)

(73) Assignee: FUKAE KASEI CO., LTD., Hyogo (JP)

(21) Appl. No.: 14/643,493

(22) Filed: Mar. 10, 2015

Related U.S. Application Data
(63) Continuation of application No. PCT/JP2013/074385, filed on Sep. 10, 2013.

(30) Foreign Application Priority Data
Sep. 13, 2012 (JP) 2012-201341

(51) Int. Cl. G01N 1/42; G01N 27/447; F26B 5/04

(52) U.S. Cl. CPC G01N 1/42; F26B 5/04; G01N 27/44743

(57) ABSTRACT

A preservation method and a preservation holder are capable of preserving a molecular weight marker for use in electrophoresis or a specimen whose molecular weight is to be estimated by electrophoresis at low cost with a hassle-free simple method. In a method for preserving a molecular weight marker or a specimen, a molecular weight marker or a specimen is preserved at normal temperature in a state in which the molecular weight marker or the specimen is held by a base section of a preservation holder in a dried state.

### RELATED APPLICATIONS

This is a continuation of International Application PCT/JP2013/074385, with an international filing date of Sep. 10, 2013, the content of which is incorporated by reference in its entirety.

### BACKGROUND OF THE INVENTION

1. Field of the Invention

The present disclosure relates to a preservation method and a preservation holder for preserving, for example, a molecular weight marker served as a reference when estimating a molecular weight of, e.g., a protein by electrophoresis, or a specimen such as a protein, an antibody, etc., whose molecular weight is to be estimated by electrophoresis.

2. Description of the Related Art

The following description of related art sets forth the inventors' knowledge of related art and certain problems therein and should not be construed as an admission of knowledge in the prior art.

In the fields of genetic engineering, medicine, biology, biochemistry, etc., when subjecting a specimen such as a DNA, a protein, an antibody, etc., to separation analysis depending on a molecular weight or a molecular size, electrophoresis using a molecular weight marker has been widely used.

In such molecular weight markers, a plurality of proteins whose molecular weights are known are generally preserved in a liquid state. For example, in Japanese Unexamined Patent Application Publication (Translation of PCT application) No. 2008-547035, a technique is disclosed in which protein molecular weight markers are stored/preserved in a liquid state at ordinary temperature of 4 to 22° C. or cryopreserved at −20° C. In this case, if the molecular weight markers in a liquid state are stored/preserved at ordinary temperature, they readily deteriorate, shortening the preservable period. Therefore, it is considered to be preferable that the molecular weight markers are preserved in a cryopreserved manner. Further, also in specimens of proteins, antibodies, etc., mentioned above, they are generally preserved in a liquid state in the same manner as in molecular weight markers.

However, in the case of cryopreserving molecular weight markers or specimens, a long-term preservation thereof can be attained, but a refrigeration equipment for the cryopreservation will be required, and it is required to thaw them at room temperature when in use. Therefore, there are problems that it causes high costs, it takes time, and it is not user friendly.

Further, in order to supply the thawed molecular weight markers or specimens to an electrophoresis device, it is required to perform operations of dispensing the molecular weight markers or specimens by sucking with a dispenser such as a pipette, etc., and dispensing to electrophoresis gel by a small amount. Also from this viewpoint, there are problems that it takes time and it is not user friendly.

The description herein of advantages and disadvantages of various features, embodiments, methods, and apparatus disclosed in other publications is in no way intended to limit the present invention. For example, certain features of the preferred described embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The preferred disclosed embodiments of the present invention have been developed in view of the above-mentioned and/or other problems in the related art. The preferred disclosed embodiments of the present invention can significantly improve upon existing methods and/or apparatuses.

The preferred embodiments of the present invention were made in view of the aforementioned conventional situation, and aim to provide a preservation method and a preservation holder capable of preserving, for example, a molecular weight marker for use in electrophoresis or a specimen whose molecular weight is to be estimated by electrophoresis at low cost with a hassle-free simple method.

According to a first aspect of some embodiments of the invention, some embodiments are directed to a method for preserving a molecular weight marker for use in electrophoresis or a specimen whose molecular weight is to be estimated by electrophoresis, including: preserving the molecular weight marker or the specimen at ordinary temperature in a state in which the molecular weight marker or the specimen is held by a preservation section provided at a base section of a preservation holder in a dried state.

According to some embodiments of the invention, it is preferable that, in the aforementioned method, the preservation section is made of a filter paper, a nonwoven fabric, etc., attached to the base section, and the molecular weight marker or the specimen is applied to the filter paper, the nonwoven fabric, etc., and then subjected to ordinary temperature drying or decompression drying.

According to some embodiments of the invention, it is preferable that, in the aforementioned method, the molecular weight marker not containing glycerol is applied to the preservation section.

According to some embodiments of the invention, it is preferable that, in the aforementioned method, a liquid mixture in which a protection agent such as sugar, alcohol, compound, etc., is mixed to a molecular weight marker not containing the glycerol is applied to the preservation section and thereafter subjected to ordinary temperature drying or decompression drying.

According to some embodiments of the invention, it is preferable that, in the aforementioned method, the preservation section to which the molecular weight marker or the specimen was applied is dried and then preserved in a sealed state.

According to some embodiments of the invention, it is preferable that, in the aforementioned method, the preservation section is supplied to an electrophoresis device in a state in which the preservation section is inserted into a storage recess formed in electrophoresis gel.

A second aspect of some embodiments of the invention, some embodiments are directed to a preservation holder for preserving a molecular weight marker for use in electrophoresis or a specimen whose molecular weight is to be estimated by electrophoresis, including at least one base section, a supporting section formed at one end of the at least one base section, and a preservation section attached to the supporting section. The molecular weight marker or the specimen is held by the preservation section in a dried state.

According to some embodiments of the invention, it is preferable that, in the aforementioned preservation holder, the preservation section is supplied to an electrophoresis device in a state in which the preservation section is inserted into a storage recess formed in electrophoresis gel.

According to some embodiments of the invention, it is preferable that, in the aforementioned preservation holder, the at least one base section includes a plurality of the base sections each formed into a band plate shape, and wherein the plurality of base sections are arranged in parallel to each other at predetermined intervals with another ends of the base sections opposite to the supporting sections detachably connected to a connection plate.

According to a third aspect of some embodiments of the invention, some embodiments are directed to a method for preserving an element to be supplied to electrophoresis gel, including: applying the element to a preservation section of a preservation holder; drying the element applied to the preservation section; and preserving the element held by the preservation section at ordinary temperature in a dried state.

According to some embodiments of the invention, since a molecular weight marker or a specimen is preserved in the preservation section provided at the base section at ordinary temperature in a dried state, as compared with a conventional case in which it is cryopreserved, a facility such as a freezer, etc., can be eliminated, which can reduce the cost, attain a long term preservation with a simple method, and further eliminate a time-consuming thawing operation when in use, which in turn can improve the usability.

Further, the molecular weight marker or the specimen in a dried state can be supplied to an electrophoresis device as it is, which can eliminate a conventional time-consuming dispensing work. Also from this viewpoint, the cost can be reduced.

According to some embodiments of the invention, the molecular weight marker or the specimen are applied to a filter paper, a nonwoven fabric, etc., and thereafter dried to be preserved. Therefore, it becomes possible to preserve the molecular weight marker or the specimen for a long period of time in a stable condition.

According to some embodiments of the invention, since the molecular weight marker not containing glycerol is applied to the preservation section, inhibitation to the molecular weight marker at the drying step can be prevented.

That is, in general, a molecular weight marker is required to be precipitated in a specified slit formed in electrophoresis gel when supplied to the gel. For this reason, in the molecular weight marker, glycerol (glycerin) is contained for precipitating the marker itself.

Such glycerol has a characteristic feature that the absorbency is extremely high, and therefore glycerol is effective for a conventional solution type molecular weight marker which is cryopreserved at −20° C. and freeze-thawed when in use, but it is not suitable for a molecular weight marker of the present invention in which a molecular weight marker is preserved in a dried state. Therefore, it is preferable to prepare a molecular weight marker not containing glycerol.

According to some embodiments of the invention, a molecular weight marker is mixed together with a protection agent such as sugar, alcohol, compound, etc., and this liquid mixture is applied to the preservation section and then subjected to ordinary temperature drying or decompression drying. This stabilizes the molecular structure, etc., of the molecular weight marker at the time of drying, which in turn can attain a long-term preservation.

Further, by mixing a protection agent to a molecular weight marker not containing glycerol, the protection agent can have both a function of stably protecting the molecular weight marker and a function of precipitating the molecular weight marker when supplied to electrophoresis. This can prevent influence due to omission of glycerol.

According to some embodiments of the invention, since the preservation section to which the molecular weight marker or the specimen was applied is preserved in a sealed state, it is possible to prevent deterioration due to contamination by air, moisture, etc., which makes it possible to considerably extend the preservation period.

According to some embodiments of the invention, since the preservation section is supplied to the electrophoresis device in a state in which the preservation section is inserted into the recess formed in the electrophoresis gel, the molecular weight marker or the specimen in a dried state can be used as it is. As a result, a conventional time-consuming dispensing work can be eliminated.

According to some embodiments of the invention, since the molecular weight marker or the specimen is preserved in a dried state in the preservation section attached to the supporting section formed at one end of the base section, a facility such as a freezer, etc., can be eliminated as mentioned above, and the thawing operation when in use can be eliminated. Accordingly, the same effects as those of claim 1 can be obtained.

Further, since the preservation section having an injection function is integrally formed at the preservation holder, the handling becomes easy, and the preservation section can be supplied to an electrophoresis device in the preserved state, which eliminates the dispensing work which requires a researcher's manipulation.

According to some embodiments of the invention, since a plurality of base sections are arranged in parallel to each other with another ends of the base sections opposite to the supporting sections detachably connected to a connection plate, a number of molecular weight markers or specimens can be preserved collectively, and can be used by separating/detaching the base section from the connection plate as needed.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims. In the drawings, the size and relative sizes of layers and regions may be exaggerated for clarity. Like numbers refer to like elements throughout. The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”. It will be understood that, although the terms first, second, etc. may be used herein to describe various elements, these elements should not be limited by these terms. Unless indicated otherwise, these terms are only used to distinguish one element from another. For example, a first object could be termed a second object, and, similarly, a second object could be termed a first object without departing from the teachings of the disclosure. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). However, the term “contact,” as used herein refers to direct contact (i.e., touching) unless the context indicates otherwise. Terms such as “same,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to reflect this meaning. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

### BRIEF EXPLANATION OF THE DRAWINGS

The preferred disclosed embodiments of the present invention are shown by way of example, and not limitation, in the accompanying figures.

FIG. 1 is a front view of a preservation holder of a molecular weight marker according to Example 1 of the present invention.

FIG. 2 is a side view of the preservation holder.

FIGS. 3A and 3B are schematic structural views each showing electrophoresis gel of the molecular weight marker.

FIG. 4A is a front view of a preservation holder according to Example 2 of the present invention, and FIG. 4B is a partial side view thereof.

FIG. 5 is a front view showing a modified Example of the preservation section of the aforementioned Example.

### DETAILED DESCRIPTION

In the following paragraphs, some preferred embodiments of the invention will be described by way of example and not limitation. It should be understood based on this disclosure that various other modifications can be made by those in the art based on these illustrated embodiments.

Hereinafter, embodiments of the present invention will be explained with reference to the attached drawings.

### Example 1

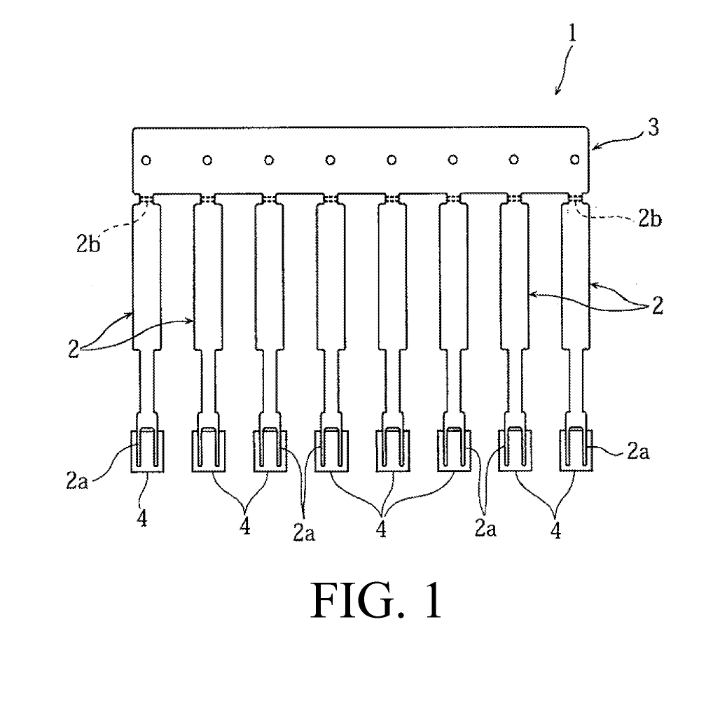

FIGS. 1 to 3 are drawings for explaining a method and a holder for preserving an element to be supplied to electrophoresis gel, for example, a molecular weight marker or a specimen such as, a protein, an antibody, etc., according to Example 1 of the present invention. In this Example, the explanation will be directed to a case in which a molecular weight marker is preserved or stored.

In figures, the reference numeral “1” denotes a preservation holder for a molecular weight marker. This preservation holder 1 has a structure in which a plurality (8 in this Example) of stick-like base sections 2 are arranged in parallel to each other at predetermined intervals with one ends thereof integrally connected to a common connection plate 3.

At the connection part of the one end of each base section 2 connecting to the connection plate 3, a thin-walled separation part (easy-to-break portion) 2b is formed by partially cutting the connection part. With this, each base section 2 can be easily detached/braked from the connection plate 3.

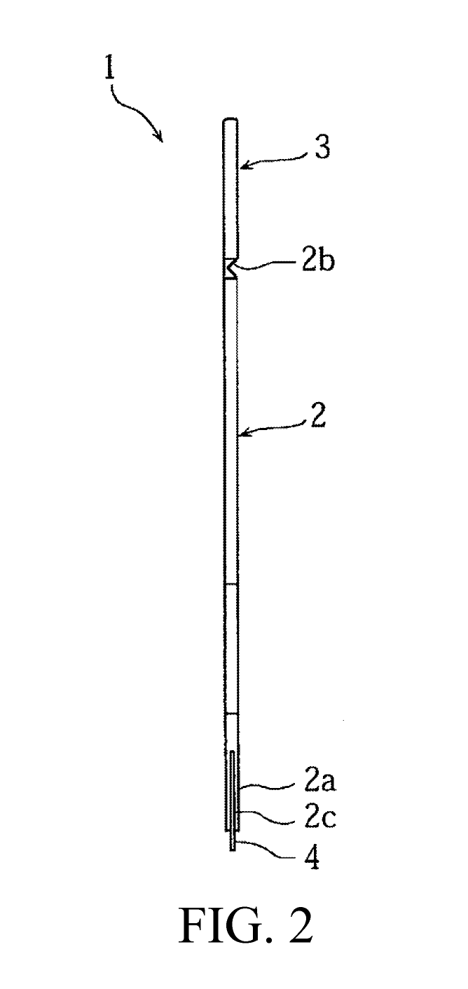

At the lower end of each base section 2, a supporting section 2a having a roughly fork shape is integrally formed. Each supporting section 2a is integrally provided with a rectangular preservation section 4. In each supporting section 2a, as shown in FIG. 2, a slit 2c is formed so as to divide the thickness of the supporting section 2a in half, and the preservation section 4 is integrally formed in the slit 2c by insert molding.

In each preservation section 4, a protein molecular weight marker is stored or held in a dried state and preserved/stored at ordinary temperature. Each preservation section 4 is made of a filter paper, a nonwoven fabric, etc. The molecular weight marker is stored/held in the filter paper, the nonwoven fabric, etc., and preserved.

In the molecular weight marker, a mixed liquid in which a protection agent such as sugar, alcohol, compound, etc., is mixed to a protein as a standard is applied to the preservation section 4, and then subjected to natural drying at a room temperature of, e.g., 15° C. or less or decompression drying with a vacuum pump, etc., to be adhered to the preservation section 4 in a permeated manner. Thereafter, the preservation holder 1 is preserved in a state in which it is accommodated in a hermetically-sealed container, which is not illustrated. This enables preservation for 3 to 6 months at room temperature of, e.g., 4 to 20° C. The molecular weight marker is subjected to drying processing in a state in which no glycerol is contained.

Even in the case of preserving proteins or specimens such as antibodies, etc., the same preservation method and preservation holder as in the aforementioned molecular weight marker are employed.

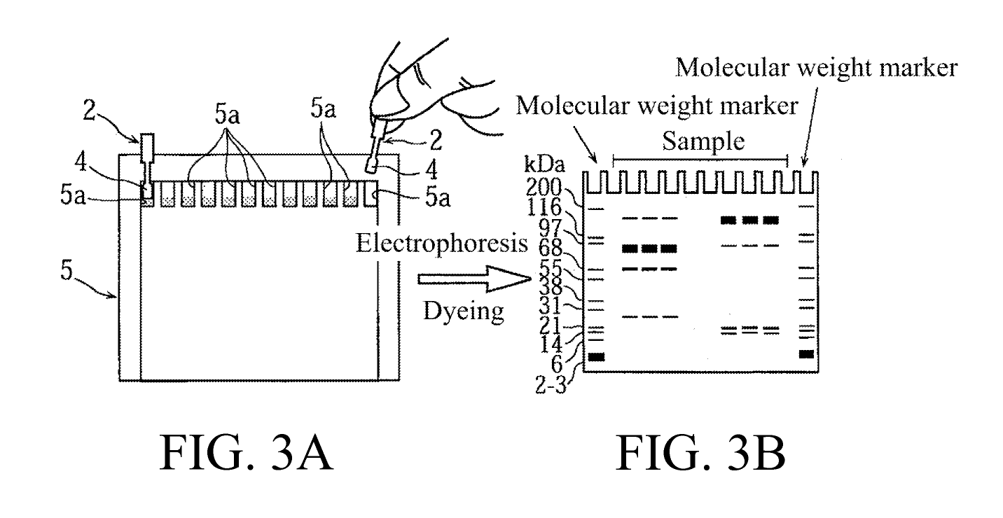

In FIGS. 3A and 3B, the reference numeral “5” denotes electrophoresis gel to for use in polyacrylamide gel electrophoresis (SDS-PAGE). At the upper end of the electrophoresis gel 5, a number of storage recesses 5a each having a size, a shape, and a thickness corresponding to the preservation section 4 are formed.

In order to obtain a molecular weight of a specimen of a sample protein as an analysis target, the preservation holder 1 is taken out from the sealed container, and in this Example, two pieces of base sections 2 are detached from the connection plate 3. Then, the preservation section 4 of each base section 2 is inserted into each of the storage recesses 5a and 5a at the left and right ends of the electrophoresis gel 5 with hand, tweezers, etc., and specimens of sample proteins are dispensed in the remaining storage recesses 5a. Since the molecular weight marker preserved in the preservation section 4 is released into the storage recess 5a during this time, upon completion of dispensing of the sample proteins, the preservation sections 4 are taken out to initiate the migration. By performing a dying operation after completion of the migration, the migration distance of each sample protein is detected. By comparing the migration distance of each sample protein with the migration distances of the molecular weight markers at the left and right ends, a molecular weight of each sample protein can be estimated. The used base section 2 will be processed as industrial waste.

According to this Example as explained above, the molecular weight marker and the sample protein specimen are preserved in the preservation section 4 integrally provided at the stick-like base section 2 at normal temperature in a dried state. Therefore, as compared with a conventional case in which they are cryopreserved, the cost can be reduced, the long term preservation can be performed with a simple method, and further a time consuming thawing operation when in use can be eliminated, which in turn can improve the usability.

Further, the molecular weight marker and the specimen in a dried state can be supplied to an electrophoresis device as it is, which can eliminate a conventional time-consuming dispensing work. Also from this viewpoint, the cost can be reduced.

In this Example, the molecular weight marker and the specimen are preserved by applying to a filter paper, a nonwoven fabric, etc. Therefore, contamination due to moisture in air, etc., can be prevented, which in turn can preserve the molecular weight marker and the specimen for a long period of time in a stable condition.

Further, a protein whose molecular weight is known is mixed to a protection agent such as sugar, alcohol, compound, etc., and this liquid mixture is applied to the preservation section 4 and then subjected to ordinary temperature drying or decompression drying. Accordingly, the molecular structure of the molecular weight marker at the time of drying can be stabilized, which in turn can attain a long-term preservation. That is, if the molecular weight marker is dried as it is, there is a risk that the molecular structure of the molecular weight marker is destroyed at the time of drying. In this Example, since the molecular weight marker is protected by sugar, alcohol, compound, etc., the molecular structure can be stabilized.

Since the molecular weight marker is dried in a state in which no glycerol is contained, influence to the molecular weight maker in the drying step can be prevented. Further, since a protection agent such as sugar, compound, etc., is mixed to a molecular weight marker not containing glycerol, the protection agent can have both a function of stably protecting the molecular weight marker and a function of precipitating the molecular weight marker at the time of supplying to electrophoresis. Accordingly, influence due to the omission of glycerol can be avoided.

In this Example, since each preservation section 4 to which the molecular weight marker or the specimen was applied is preserved in a state of being sealed with a sealing container, etc., it is possible to prevent deterioration due to contamination by air, moisture, etc., which makes it possible to considerably extend the preservation period.

Further, since the preservation section 4 is supplied to the electrophoresis device in a state in which the preservation section 4 is inserted into the storage recess 5a formed in the electrophoresis gel 5, the molecular weight marker and the specimen in a dried state can be used as it is. Therefore, a conventional time-consuming dispensing work can be eliminated.

According to the preservation holder 1 of this Example, it is configured such that a fork-shaped supporting section 2a is integrally formed at the tip end of the base section 2 and the molecular weight marker or the specimen is preserved in the preservation section 4 insert-formed to the supporting section 2a in a dried state. Therefore, a facility such as a freezer, etc., mentioned above can be eliminated, and the thawing operation when in use can be eliminated.

Further, since the preservation section 4 to be inserted into the storage recess 5a of the electrophoresis gel 5 is integrally formed at the preservation holder 1, the handling becomes easy, and the preservation section 4 can be supplied to an electrophoresis device in the preserved state, which eliminates a dispensing work requiring a researcher's manipulation.

Further, since the base sections 2 are arranged in parallel to each other and connected to a common connection plate 3 in a detachable manner, a number of molecular weight markers or specimens can be preserved collectively, and can be used by detaching the base section 2 from the connection plate 3 as needed.

### Example 2

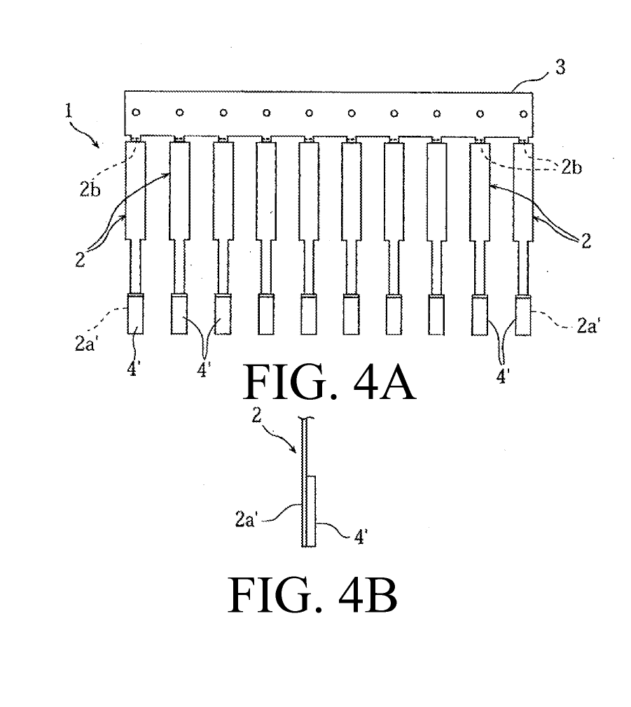

FIGS. 4A and 4B are views for explaining a preservation holder according to Example 2 of the present invention. In these figures, the same symbol as in FIG. 1 denotes the same or corresponding portion.

The preservation holder 1 of Example 2 has a structure in which upper ends of ten base sections 2 are integrally connected to a common connection plate 3. At the lower end of each base section 2, a plate shaped supporting section 2a′ is integrally formed. A rectangular preservation section 4′ made of a filter paper, a nonwoven fabric, etc., is adhesively fixed to the supporting section 2a′. This preservation section 4′ is about 1.0 mm or more in width.

In Example 2, since the supporting section 2a′ of each base section 2 is formed into a flat-plate like shape and the preservation section 4′ is adhered to the supporting section 2a, the structure can be simplified as compared with the supporting section of Example 1

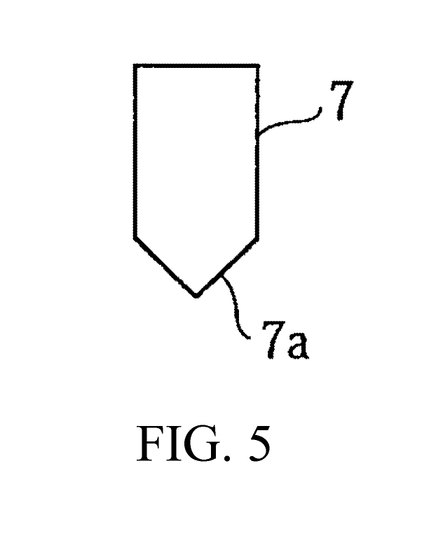

In Examples 1 and 2, the explanations were directed to the case in which the preservation section 4 (4′) was formed into a rectangular shape, but the shape of the preservation section of the present invention is not limited to this. For example, as shown in FIG. 5, the preservation section 7 can be formed into a so-called home base shape having a tapered portion 7a which becomes narrower toward the tip end. In this case, the insertion into the electrophoresis gel can be performed easily.

The terms and descriptions used herein are used only for explanatory purposes and the present invention is not limited to them. Accordingly, the present invention allows various design-changes falling within the claimed scope of the present invention unless it deviates from the spirits of the invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, the terminology “present invention” or “invention” is meant as a non-specific, general reference and may be used as a reference to one or more aspects within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features.

What is claimed is:

1. A method for preserving a molecular weight marker for use in electrophoresis or a specimen whose molecular weight is to be estimated by electrophoresis, comprising:
preserving the molecular weight marker or the specimen at ordinary temperature in a state in which the molecular weight marker or the specimen is held by a preservation section provided at a base section of a preservation holder in a dried state.

2. The method according to claim 1,
wherein the preservation section is made of a filter paper or a nonwoven fabric attached to the base section, and
wherein the molecular weight marker or the specimen is applied to the filter paper or the nonwoven fabric and then subjected to ordinary temperature drying or decompression drying.

3. The method according to claim 2, wherein the molecular weight marker not containing glycerol is applied to the preservation section.

4. The method according to claim 3, wherein a liquid mixture in which a protection agent is mixed to the molecular weight marker not containing glycerol is applied to the preservation section and thereafter subjected to ordinary temperature drying or decompression drying.

5. The method according to claim 1, wherein the preservation section to which the molecular weight marker or the specimen was applied is dried and then preserved in a sealed state.

6. The method according to claim 1, wherein the preservation section is supplied to an electrophoresis device in a state in which the preservation section is inserted into a storage recess formed in electrophoresis gel.

7. A holder for preserving a molecular weight marker for use in electrophoresis or a specimen whose molecular weight is to be estimated by electrophoresis, comprising:
at least one base section;
a supporting section formed at one end of the at least one base section; and
a preservation section attached to the supporting section,
wherein the molecular weight marker or the specimen is held by the preservation section in a dried state.

8. The holder according to claim 7, wherein the preservation section is supplied to an electrophoresis device in a state in which the preservation section is inserted into a storage recess formed in electrophoresis gel.

9. The holder according to claim 7, wherein the at least one base section includes a plurality of base sections each formed into a band plate shape, and wherein the plurality of base sections are arranged in parallel to each other at predetermined intervals with another ends of the base sections opposite to the supporting sections detachably connected to a connection plate.

10. The holder according to claim 9, wherein the another end portions of the base sections and the connection plate are each connected via an easy-to-break portion.

11. A method for preserving an element to be supplied to electrophoresis gel, comprising:
applying the element to a preservation section of a preservation holder;
drying the element applied to the preservation section; and
preserving the element held by the preservation section at ordinary temperature in a dried state.

12. The method according to claim 11, further comprising:
storing the preservation holder in a sealed container.

13. The method according to claim 11, wherein the element is a molecular weight marker for use in electrophoresis or a specimen whose molecular weight is to be estimated by electrophoresis.

14. The method according to claim 13, wherein the specimen is a protein or an antibody.

15. The method according to claim 11, wherein drying the element is performed by ordinary temperature drying or decompression drying.

16. The method according to claim 11, wherein the preservation section is made of a filter paper or a nonwoven fabric.

17. The method according to claim 13, wherein the molecular weight marker is applied to the preservation section in a state in which the molecular weight marker does not contain glycerol.
